(19) United States
(12) Patent Application Publication
(10) Pub. No.: US 2016/0094323 A1
(43) Pub. Date: Mar. 31, 2016

(54) INTERCELL INTERFERENCE CONTROL THROUGH CONTROL SIGNAL PROVIDED BY TERMINAL

(71) Applicant: INTELLECTUAL DISCOVERY CO., LTD., Seoul (KR)

(72) Inventors: Jinsam KWAK, Uiwang-si (KR); Juhyung SON, Uiwang-si (KR)

(73) Assignee: INTELLECTUAL DISCOVERY CO., LTD., Seoul (KR)

(21) Appl. No.: 14/787,804

(22) PCT Filed: Apr. 30, 2014
(86) PCT No.: PCT/KR2014/003880

§ 371 Date: Oct. 29, 2015

(30) Foreign Application Priority Data
Apr. 30, 2013 (KR) 10-2013-0048982
Apr. 30, 2013 (KR) 10-2013-0048984
Apr. 30, 2013 (KR) 10-2013-0048986

(51) Int. Cl. H04L 5/00; H04W 40/16

(52) U.S. Cl. CPC H04L 5/0048; H04L 5/0007; H04W 40/16

(57) ABSTRACT

The present disclosure relates to a wireless communication system, and more particularly to a method for transmitting a reference signal in a wireless communication system. A new structure allows coexistence of a control channel and a data cannel in one time-frequency resource, thereby increasing efficiency of resources. The data and control channels coexist using a time division scheme. The coexistent control channels reallocate regions of the control signal and reference signal to maintain reliability of the control signal. Also proposed are an auxiliary control signal for measuring or controlling inter-cell interference and a method for thereby controlling interference of a base station/terminal. A new control channel structure is designed for transmitting the auxiliary control signal, whereby enabling coexistence with the legacy terminal. This provides a method for transmission/reception of relevant information between the base station and terminals to prevent erroneous operation of the legacy terminal.

### TECHNICAL FIELD

The present disclosure relates to wireless communications. More particularly, the present disclosure relates to a method for transmitting a control signal in a wireless communication system.

### BACKGROUND

A Third Generation Partnership Project (3GPP) wireless communication system based on wideband code division multiple access (WCDMA) radio access technology has been widely deployed throughout the world. High speed downlink packet access (HSDPA), which can be defined as the first evolutionary step of WCDMA, provides 3GPP with a wireless connection technology having a high competitiveness in the near future.

There is an Evolved Universal Mobile Telecommunication System (E-UMTS) intended to provide a competitive edge in the future. Having evolved from existing WCDMA UMTS, the E-UMTS is in the process of standardization in the 3GPP. The E-UMTS is also referred to as a Long Term Evolution (LTE). For more information on the UMTS and E-UMTS technical specifications, reference can be made to “3rd Generation Partnership Project; Technical Specification Group Radio Access Network” Release 8 or later.

The E-UMTS generally involves a user terminal or equipment (UE), a base station and an access gateway (AG) located at an end of a network (E-UTRAN) and is connected to an external network. Typically, the base station can transmit multiple data streams at the same time for the purpose of al broadcast service, a multicast service and/or a unicast service. The LTE system utilizes an Orthogonal Frequency Divisional Multiplexing (OFDM) and multi-antenna Multiple Input Multiple Output (MIMO) to perform downlink transmissions for a variety of services.

The OFDM is a high-speed downlink data access system. It has an advantage of high spectral efficiency, whereby all allocated spectrums can be used by all base stations. A transmission band for an OFDM modulation is divided into multiple orthogonal subcarriers in frequency domain and into a plurality of symbols in time domain. The division of transmission bands in the OFDM into multiple orthogonal subcarriers enables the deduction of the bandwidth for each subcarrier and increasement of the modulation time for each carrier wave. The plurality of subcarriers are transmitted in parallel and therefore digital data or symbol transmission rates of a particular subcarrier are lower than those of the single carrier.

The multi-antenna or the MIMO system is a communication system using multiple transmission and receive antennas. With increasing number of transmission and receive antennas, the MIMO system can linearly increase the channel capacity without additional increase of bandwidth. MIMO technology adopts a spatial diversity scheme that can enhance reliability of transmission by utilizing symbols passing through a variety of channel paths and a spatial multiplexing scheme for increasing the transmission rate with a plurality of transmit antennas respectively transmitting separate data streams at the same time.

The MIMO technology can be classified into an open-loop MIMO technology and closed-loop MIMO technology, depending on whether the transmitting end possesses a channel information. The transmitting end in the open-loop MIMO has no knowledge of the channel information. Examples of the open-loop MIMO technology include PARC (per antenna rate control), PCBRC (per common basis rate control), BLAST, STTC, random beamforming and the like. On the other hand, the transmitting end in the closed-loop MIMO technology possesses the channel information. The performance of the closed-loop MIMO system is dependent on the accuracy of knowledge about the channel information. Examples of the closed-loop MIMO technology include PSRC (per stream rate control), TxAA and the likes.

The channel information refers to an information on a wireless channel (e.g., attenuation, phase shift or time delay, etc.) between multiple transmit antennas and multiple receive antennas. The MIMO system establishes a variety of stream paths through combinations of a plurality of transmission and receive antennas and has fading characteristics by which the channel state shows an irregular variation by time in time/frequency domain due to multipath time delay. Therefore, the transmitting end calculates the channel information via channel estimation. The channel estimation is designed to estimate the channel information needed to reconstruct the transmitted signal after distortion. For example, the channel estimation refers to estimating the magnitude and reference phase of a carrier wave. In other words, the channel estimation serves to estimate the frequency response of the radio band or the wireless channel.

Transmission of control signals in time, spatial and frequency domains is essential to implementing various transmission or reception techniques for high-speed packet transmission. A channel for transmitting control signals is called a control channel. There may be various kinds of uplink control signals including an acknowledgement (ACK)/negative-acknowledgement (NACK) signal which is a response to a downlink data transmission, a channel quality indicator (COI) for indicating a downlink channel quality, a precoding matrix index (PMI), and a rank indicator (RI).

In general, the control channel uses a further limited number of time-frequency resources compared to the data channel. To increase the spectral efficiency and multi-user diversity gain of a system, feedback of state information on the wireless channel is needed. Accordingly, efficient control channel design for high-volume feedback is inevitable. In addition, in order to lower power consumption of a terminal, the control channel needs to be designed to have a good peak-to-average power ratio (PAPR)/cubit metric (CM).

In the long term evolution (LTE) mobile communication standard based on 3rd generation partnership project (3GPP) technical specification (TS) Release 8 and later versions, physical channels for LTE may be divided into data channels of a physical downlink shared channel (PDSCH) and a physical uplink shared channel (PUSCH), and control channels of a physical downlink control channel (PDCCH) and a physical uplink control channel (PUCCH), as disclosed in 3GPP TS 36.211 V8.4.0 (2008-09) “Evolved Universal Terrestrial Radio Access (E-UTRA); Physical Channels and Modulation (Release 8)”.

The PDCCH, which is a downlink control channel, carries a downlink grant for the reception of PDSCH by a terminal and an uplink grant for the transmission of PUSCH by the terminal. The PUCCH, which is an uplink control channel, carries uplink control signals including, for example, an ACK/NACK signal for hybrid automatic repeat request (HARQ), a channel quality indicator (CQI) indicating a downlink channel state, and a scheduling request (SR) for a radio resource allocation for uplink transmission. For the control channels, transmission reliability may be more important than transmission capacity. This is because the occurrence of an error in transmission on a control channel may prohibit the data channel to be received, or seriously affect scheduling or HARQ implementation. Accordingly, the payload of a control channel is generally limited to a few bits to tens of bits. In addition, for an uplink control channel, the PAPR/CM property is important for power management of a terminal. To ensure long standby time and lower battery consumption, the uplink control channel needs to have a low PAPR/CM.

### DISCLOSURE

### Technical Problem

Therefore, the present disclosure provides a method for transmitting a reference signal suitable for a small cell by using a common reference signal.

The present disclosure further provides an apparatus for transmitting a common reference signal and a demodulation reference signal suitable for the channel environment of the small cell and for the allocation of additional resources.

Every time a communication system evolves, performance improvement of existing systems is preferred over a new system definition for the ever-changing communication technology as a way of achieving the objectives at the minimum possible cost. In particular, the communication system has possible influences not just on RF interfaces of terminals or base stations but also on all infrastructure facilities, and therefore minimizing change of the system may be commercially significant. In this context, a new version of communication system will be restricted to maintain the characteristics of the existing system. Particularly, an important requirement is to provide the functionality of the new system without degrading the performance of the existing system, which is applied to LTE/LTE-A release 8/9/10 or later versions. The same requirement also applies to IEEE 802.16m and other communication systems when they are required to ensure operation of legacy systems. The performance improvement basically involves techniques including increasing the modulation order or the number of antennas and reducing the effects of interference, which requires more feedback information. In other words, transmission of control signals in time, spatial and frequency domains is essential to implementing various transmission or reception techniques for high-speed packet transmission. A channel for transmitting control signals is called a control channel. Active discussion is underway on the methods for maximizing the efficiency of limited radio resources by causing the transmitter to effectively perform retransmission based on the feedback information in the receiver.

Since reliability of the control signal is associated with the system reliability, it is necessary to increase the reliability related to the detection of a control signal on the control channel. There is a need for a control channel structure which is robust to a varying channel environment while increasing terminal capacity and transmission capacity. Further, in various cell topologies such as a femtocell and a picocell with cell coverage whose range is less than 100 m like the small cell, the wireless channel delay characteristics experienced by each cell are different from those of cells with larger coverages, which makes it desirable to design the control channel structure taking into account the two kinds of channel characteristics.

1) Frequency selectivity of the wireless channel: On the wireless channel defined by delay spread, signals are received through multiple paths with various delay times. Thereby, the wireless channel has a delay profile defined by a plurality of delays not defined as an impulse function. This fails to provide a constant channel gain but causes a channel to be changed in frequency domain, which is said to have a frequency selectivity. For small cells, the small coverage and the mostly indoor environment that is different in channel characteristics from a relatively poor environment of the mobile communications may reduce the delay spread time to a few nanoseconds. This means an insignificant frequency selectivity to cause a large coherent bandwidth, resulting in similar channel characteristics between neighboring subcarriers.

2) Time selectivity of the wireless channel: In order to reduce the occurrence of frequent handover resulting from the configuration of small cells, small cells are appropriately used by pedestrians or stationary users, and accordingly mobility of the terminal may be restricted to a slow-moving/stationary state. This mitigates the Doppler effect affecting the change of the wireless channel to have the time selectivity of the radio channel different from fast-moving objects and then lead to a reduced channel variation between neighboring symbols. This prolongs the coherent time, resulting in a reduced channel variation between temporally neighboring subcarriers.

In addition to the advantage of time-frequency channel change that the small cell has, the small cell having less terminals than those of a macrocell necessitates a reconsideration of the multiplexing feature of control channels also. In other words, there is a need for reducing the overhead of control channel resources to efficiently utilize resources in the current legacy control channel structure and to support a smaller number of terminals than in a macrocell by using minimum resources in a control channel structure that is supportable in the small cell coverage. In addition, it may also be necessary to secure new resources for transmission of new control channel information of a terminal for supporting only the small cell.

In view of the conventional art as indicated above, some embodiments of the present disclosure provide a method for transmitting a control information by efficiently utilizing resources of a uplink control channel in consideration of the small cell environment in a wireless communication system for transmitting an uplink control signal, and a signaling method thereof.

Another embodiment of the present disclosure is to provide a method for transmitting a new uplink control channel by expanding a control information specific to a small cell supporting terminal.

Another embodiment of the present disclosure is to provide a method for transmitting/receiving a reference signal with a backward compatibility retained when expanding the uplink control channel, and a signaling method thereof.

Objects of the present disclosure are not limited to the aforementioned technical matters, and other unmentioned objects of the present disclosure will become apparent to those having ordinary skill in the art from the following description.

### SUMMARY

Some embodiments of the present disclosure provide a cellular communication system using uplink control signals with a control signal transmission channel and a data transmission channel coexisting in one time-frequency resource allocation region. The one time-frequency resource allocation region includes one physical resource block, and the control signal transmission channel includes PUCCH as an uplink control channel. The coexistence of the control signal transmission channel and data transmission channel does not employ a frequency hopping by the unit of slot by the control channel, but is provided in a subframe through a time division multiplexing.

In accordance with some embodiments of the present disclosure, a method for transmitting a control signal in a wireless communication system includes allocating OFDM symbols in a slot for the transmission of the control signal, allocating the OFDM symbols in the slot for a data transmission, and allocating a common reference signal for a control and a data transmission. The number of the OFDM symbols in the slot allocated for the transmission of the control signal and data is 4 or less, and the number of the OFDM symbols in the slot allocated for the transmission of the reference signal is 3 or less. Allocating control and data channels to the same user is allowed in the same time-frequency, and a time-domain spread code less than or equal to 4 in length is used to transmit the control signal. The control signal carries 1 or 2-bit information control information as ACK/NACK or SR.

In accordance with some embodiments of the present disclosure, a method for transmitting a control signal in a wireless communication system includes allocating OFDM symbols in a slot for a transmission of the control signal; allocating the OFDM symbols in the slot for a data transmission; allocating a common reference signal to different symbols for a control and a data transmission. The number of the OFDM symbols in the slot allocated for the transmission of the control signal and data signal is 4 or less, and the number of the OFDM symbols in the slot allocated for the transmission of the reference signal is 3 or less. Allocating control and data channels to the same user is not allowed in the same time-frequency, and a time-domain spread code less than or equal to 4 in length is used to transmit the control signal. The control signal includes ACK/NACK, SR and CQI.

In accordance with some embodiments of the present disclosure, a method for transmitting a plurality of control signals and data in one subframe in a wireless communication system includes configuring a transmission resource for a first control signal with the same symbols as a transmission resource for a second control signal, allocating a reference signal in the transmission resource of the first control signal and a reference signal in the transmission resource of the second control signal to the same symbol, allocating different cyclic shifts of a specific sequence to distinguish between the first control signal and the second transmission signal, and transmitting the subframe. The first control signal and the second control signal have PUCCH format 1, 2 or 3, and the specific sequence has a specific root index of a Zad-off Chu sequence. In addition, the control signal transmission resources do not overlap data transmission resources in one subframe.

In accordance with some embodiments of the present disclosure, a cellular communication system involving a plurality of base stations including a macrocell is configured to perform steps including acquiring, by a terminal, an interference information of a neighbor cell from signals received from the plurality of base stations, transmitting, by the terminal, the interference information of the neighbor cell to a serving base station, determining a neighbor cell interference control request based on one or more interference informations received from one or more terminals, and transmitting an interference control information to a nearby base station. The interference information of the neighbor cell includes at least one of a picocell, a microcell and a femtocell as a small cell, and the terminal transmits the interference information of the neighbor cell to the base station by using a time-frequency resource which is a common resource for use by the terminals, wherein the interference informations of a plurality of the terminals received in the form of the common resource is acquired through a detection of a power or energy level.

In accordance with some embodiments of the present disclosure, a cellular communication system involving a plurality of base stations including a macrocell is configured to perform steps including allocating, by a base station, a radio resource to a terminal for a signal detection by the terminal, transmitting an additional control information of the terminal through the allocated resource, and generating and transmitting, by the base station, a control signal based on a received control information of the terminal. The resource allocated by the base station indicates a region of PUCCH, and the additional control information allows the base station to detect a signal strength of the terminal, or provides the base station with an interference information of a neighbor cell. The control signal generated by the base station is a terminal request information for checking an access or serviced state of the terminal, and includes a information for controlling an interference of a nearby base station. A new control information of the base station is operative optionally based on the additional control information transmitted by the terminal. In addition, the new control information of the base station is transmitted after a maximum number of HARQ retransmissions is reached.

In accordance with some embodiments of the present disclosure, a method for transmitting a control signal in a wireless communication system includes allocating four OFDM symbols in a slot for a transmission of the control signal, and spreading the control signal in time domain by using a length-4 sequence [+1, +1, −1, −1] to transmit the control signal. The control signal includes a cell specific control information, the cell having a small coverage. The control signal includes a signal for detecting a user signal strength, and an information indicating interference of a neighbor cell. The control signal is transmitted through an M-QAM modulation or modulated by variations of energy or power level, and it may coexist with PUCCH Format 1 or 2.

### Advantageous Effects

According to some embodiments of the present disclosure, the following effects are provided.

According to at least one embodiment of the present disclosure, the overhead of the uplink control signal may be minimized, and data and control signal resources may be more efficiently used.

The present disclosure in at least one embodiment provides a structure and an operational principle of a channel for a control signal for measuring and effectively managing an interference between neighbor cells.

Effects that can be obtained from the present disclosure are not limited to the aforementioned, and other effects may be clearly understood by those skilled in the art from the descriptions given below.

### [BRIEF DESCRIPTION OF DRAWINGS]

To facilitate understanding of the present disclosure, the accompanying drawings included as part of the detailed description provide some embodiments of the present disclosure and an explanation of the technical idea of the present disclosure in conjunction with the detailed description.

FIG. 1 is a diagram of the structure of a radio frame used in 3GPP LTE.

FIG. 2 is a diagram of a resource grid for one downlink slot.

FIG. 3 is a diagram of the structure of a downlink radio frame.

FIG. 4 is a diagram of a time-frequency resource structure for the transmission of an uplink control signal in 3GPP LTE.

FIG. 5 is a diagram of a control channel structure in one slot for the transmission of a scheduling request (hereinafter, SR) signal and ACK/NACK as PUCCH format 1/1a/1b.

FIG. 6 is a conceptual diagram of transmitting the ACK/NACK that supports a downlink carrier aggregation.

FIG. 7 is a diagram of a control channel structure in one slot for the transmission of channel quality information (hereinafter, C01) as PUCCH format 2.

FIG. 8 is a diagram of a control channel structure for the transmission of ACK/NACK information about aggregation of a plurality of carriers for PUCCH format 3.

FIG. 9 is a diagram of a method for eliminating a frequency hopping with a new PUCCH structure suitable for a small cell.

FIG. 10 is a diagram of a method for additionally allocating PUSCH after eliminating the frequency hopping with a new PUCCH structure suitable for the small cell.

FIG. 11 is a diagram of a method for additionally allocating PUSCH taking into account the frequency hopping with a new PUCCH structure suitable for the small cell.

FIG. 12 is a diagram of the structure of a new PUCCH format 1 per slot suitable for a small cell to which a reference signal sharing is applied.

FIG. 13 is a diagram of the structure of a new PUCCH format 1 per slot which is suitable for a small cell and assigned a PUSCH-specific reference signal.

FIG. 14 is a diagram of the structure of a new PUCCH format 2 per slot suitable for a small cell.

FIG. 15 is an examplary diagram of the coexistence of different PUCCH formats and PUSCHs in the same PRB by using the cyclic shift of a ZC sequence.

FIG. 16 is a diagram of an interference scenario taking into account a neighboring macrocell in a small cell environment.

FIG. 17 is an examplary of a cooperation between base stations based on feedback from a terminal with a macro/small cell interference coordination.

FIG. 18 is a diagram of a process, performed by a base station, for recognizing the state of interference of a terminal and controlling the interference with a macro/small cell interference coordination.

FIG. 19 is a diagram of a specific operational process of a base station for detecting a user signal.

FIG. 20 is a diagram of a proposed transmission channel structure of small cell-specific control information in association with the detection of the user signal.

### DETAILED DESCRIPTION

Some embodiments described herein are intended to clearly explain the concept of the present disclosure to those of ordinary skill in the art to which this disclosure pertains, not to limit the present disclosure thereto, and the scope of the disclosure should be construed to include modifications and variations that do not depart from the technical idea of the disclosure.

The accompanying drawings and terms used in this specification are intended to facilitate explanation of the present disclosure, and the shapes illustrated in the drawings are exaggerated as needed to aid in understanding of the present disclosure. Therefore, the present disclosure is not to be limited by the terms and accompanying drawings that are used herein.

Further, in the following description of the at least one embodiment, a detailed description of known functions and configurations incorporated herein will be omitted so as not to obscure the subject matter of the present disclosure.

Configuration, operation and other features of the present disclosure will be readily understood from embodiments of the present disclosure described herein with reference to the accompanying drawings. Some embodiments described below are example applications of technical features of the present disclosure to a wireless communication system. The wireless communication system may support at least one of SC-FDMA, MC-FDMA and OFDMA. Hereinafter, an exemplary description will be given of a method for allocating an additional reference signal over various channels. While the description of a 3GPP LTE channel will be basically given in this specification, examples in this specification may also be applied to a reference signal allocation method utilizing a control channel of IEEE 802.16 (or a revised version thereof) or control channels of other systems.

Abbreviations used herein are as follows:

RE: Resource element

REG: Resource element group

CCE: Control channel element

CDD: Cyclic delay diversity

RS: Reference signal

CRS: Cell specific reference signal or cell common reference signal

CSI-RS: Channel state information reference signal

DM-RS: Demodulation reference signal

MIMO: Multiple input multiple output

PBCH: Physical broadcast channel

PCFICH: Physical control format indicator channel

PDCCH: Physical downlink control channel

PDSCH: Physical downlink shared channel

PHICH: Physical hybrid-ARQ indicator channel

PMCH: Physical multicast channel

PRACH: Physical random access channel

PUCCH: Physical uplink control channel

PUSCH: Physical uplink shared channel

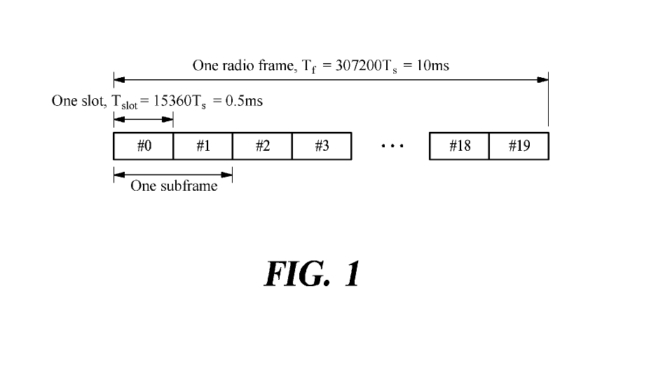

FIG. 1 is a diagram of the structure of a radio frame used in 3GPP LTE.

Referring to FIG. 1, a radio frame has a duration of 10 ms (327200xTs) and includes ten equal-sized subframes. Each subframe has a duration of 1 ms and is composed of two slots. Each slot has a duration of 0.5 ms (15360xTs). Herein, Ts denotes a sampling time, and is expressed as Ts=1/(15 kHz×2048)=3.2552×10-8 (about 33 ns). Each slot includes a plurality of OFDM symbols in time domain and a plurality of resource blocks in frequency domain. A transmission time interval (TTI), which is a unit time duration for which data is transmitted, may be defined by unit of at least one subframe. The structure of the radio frame described above is simply illustrative. The number of subframes included in a radio frame, the number of slots included in a subframe, or the number of OFDM symbols included in a slot may be changed as necessary.

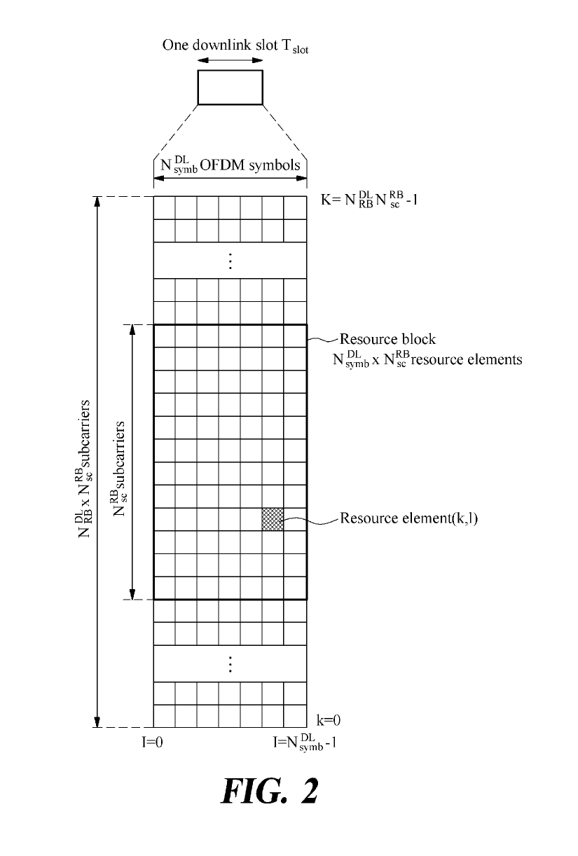

FIG. 2 is a diagram of a resource grid of one downlink slot. Referring to FIG. 2, a downlink slot includes N^{DL}_{symb} OFDM symbols in time domain and N^{DL}_{RB} resource blocks in frequency domain. Each resource block includes N^{RB}_{sc} subcarriers, and thus one downlink slot includes N^{DL}_{RB}×N^{RB}_{sc} subcarriers in frequency domain. While FIG. 2 illustrates a downlink slot as including seven OFDM symbols and a resource block as including twelve subcarriers, embodiments of the present disclosure are not limited thereto. For example, the number of OFDM symbols included in a downlink slot may be changed depending on the length of a cyclic prefix (CP). Each element on the resource grid is called a resource element and is indicated by one OFDM symbol index and one subcarrier index. One resource block is made of N^{DL}_{symb}×N^{RB}_{sc} REs. The number of resource blocks included in a downlink slot (N^{DL}_{RB}) depends on the downlink transmission bandwidth set in a cell.

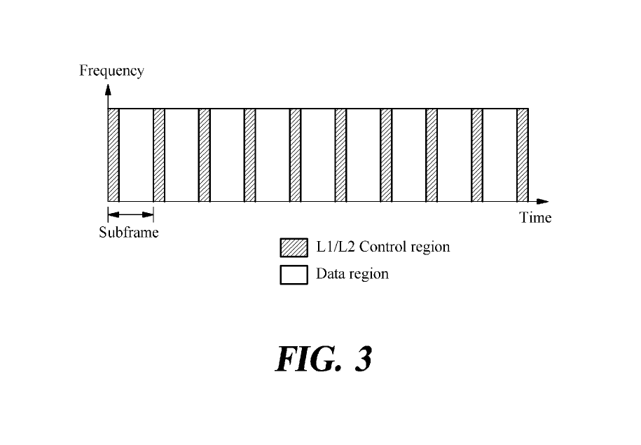

FIG. 3 is a diagram of the structure of a downlink radio frame.

Referring to FIG. 3, a downlink radio frame includes ten equal-sized subframes. Each subframe includes a Layer 1/Layer 2 (L1/L2) control region and a data region. Hereinafter, the L1/L2 control region will be simply referred to as a control region, unless specifically mentioned otherwise. The control region starts from the first OFDM symbol of a subframe and includes one or more OFDM symbols. The size of the control region may be independently set for each subframe. The control region is used to transmit an L1/L2 control signal. To this end, control channels such as PCFICH, PHICH and PDCCH are allocated to the control region. On the other hand, the data region is used to transmit downlink traffic. PDSCH is allocated to the data region.

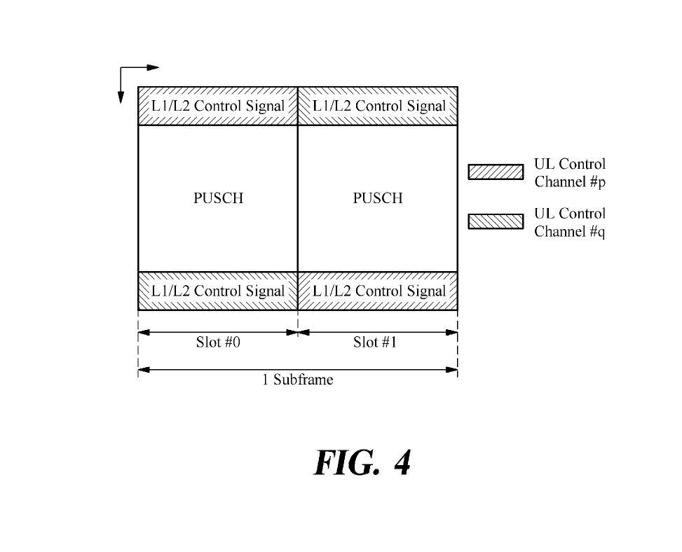

FIG. 4 is a diagram of a time-frequency resource structure for the transmission of an uplink control signal in 3GPP LTE.

Referring to FIG. 4, a channel structure is designed by allocating a part of both end bands of the whole system band, taking into account of a diversity gain through a slot-based frequency hopping. Maximizing the frequency efficiency and multi-user diversity gain of OFDM(A) with respect to such limited time-frequency resources for control channels needs a feedback of a state information of the wireless channel, requiring an efficient channel structure design for high-capacity feedback in a broadband system.

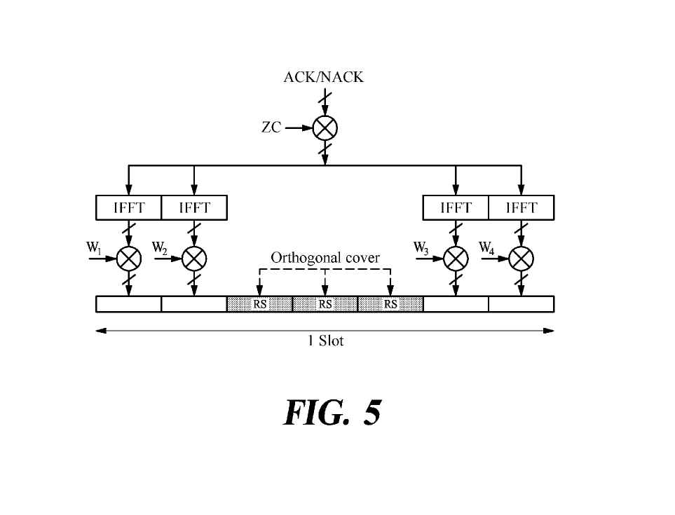

FIG. 5 is a diagram of a control channel structure in one slot for the transmission of a scheduling request or SR signal and ACK/NACK as PUCCH format 1/1a/1b.

Referring to FIG. 5, the same signal is repeatedly transmitted through slot-based frequency hopping in one subframe as in the example of FIG. 4 to obtain a frequency diversity gain in the order of 3 dB. The same structure of the control channel region pre-allocated to transmit a time-frequency spread ACK/NACK signal as above is also employed when a terminal transmits an SR for the transmission of uplink data.

The ACK/NACK channel is the destination control channel to transmit an acknowledgment (ACK)/negative-acknowledgment (NACK) signal for performing a hybrid automatic repeat request (HARQ) of downlink data. An ACK/NACK signal is a signal confirming the transmission and/or reception of the downlink data. Referring to FIG. 5, one slot includes seven OFDM symbols that have three contiguous OFDM symbols in the middle each carrying a reference signal or RS and the other four OFDM symbols for carrying the ACK/NACK signal. The reference signal is carried on the three contiguous OFDM symbols in the middle of the slot.

When a control signal is transmitted within a pre-assigned band, frequency-domain spread and time-domain spread are applied simultaneously in order to increase the number of terminals or control channels which can be multiplexed. In order to spread the ACK/NACK signal in frequency domain, a frequency-domain spread sequence is used as a base sequence. As the frequency-domain sequence, a Zadoff-Chu (ZC) sequence may be used, which is one of Constant Amplitude Zero Auto-Correlation (CAZAC) sequences.

The k-th element c(k) of a ZC sequence that is assigned index M may be expressed as follows.

$$c ( k ) = exp \{ - \frac{jπ Mk ( k + 1 )}{N} \} , when N is odd number \\ c ( k ) = exp \{ - \frac{jπ {Mk}^{2}}{N} \} , when N is even number \qquad Equation 1$$

Herein, N is the length of the ZC sequence, index M is a natural number less than or equal to N, and M and N are relative primes. Control channels may be distinguished from each other by applying base sequences having different cyclic shift values. The number of available cyclic shifts may vary depending on the delay spread of a channel. The ACK/NACK signal spread in frequency domain undergoes IFFT and is then spread in time domain by using a time-domain sequence. For example, the ACK/NACK signal is spread by using a length-4 orthogonal sequence (w0, w1, w2, w3) for four OFDM symbols. The reference signal is also spread by using a length-3 orthogonal sequence. This operation is called orthogonal covering. Thereby, three orthogonal covering sets are generated in time domain, and when up to twelve cyclic shifts of ZC are used, thirty six UEs may be multiplexed in the structure of one PUCCH Format 1.

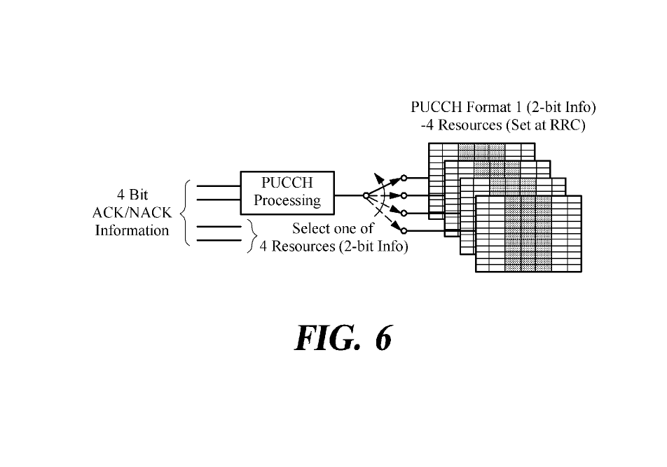

FIG. 6 is a conceptual diagram of transmitting the ACK/NACK that supports a downlink carrier aggregation.

Referring to FIG. 6, the transmission of ACK/NACK information is closely related to a downlink carrier. If a plurality of downlink carriers is aggregated, one PDSCH per downlink component carrier may be scheduled and thus a plurality of PDSCHs may be scheduled for one terminal at the same time. Accordingly, a plurality of acknowledgements (one acknowledgement per downlink component carrier or two acknowledgements in the case of spatial multiplexing) is supposed to be delivered via uplink channel. PUCCH format 1 may use a resource selection to support greater acknowledgements than 2 bits on uplink. Suppose that 4 bits need to be transmitted via uplink channel. Through the resource selection, 2 bits first indicate which PUCCH resource is to be used and the other 2 bits are transmitted on the resource indicated by the first 2 bits, by using a normal PUCCH structure. In FIG. 6, when four PUCCH resources are needed overall, one resource is known through the first CCE by using the same rule as applied as when there is no carrier aggregation (assuming that scheduling allocation is transmitted on and related to a primary component carrier), and the other resources are semi-statically configured through RRC signaling. If more than 4 bits are to be transmitted, PUCCH format 3, an addition to LTE release 10, is used.

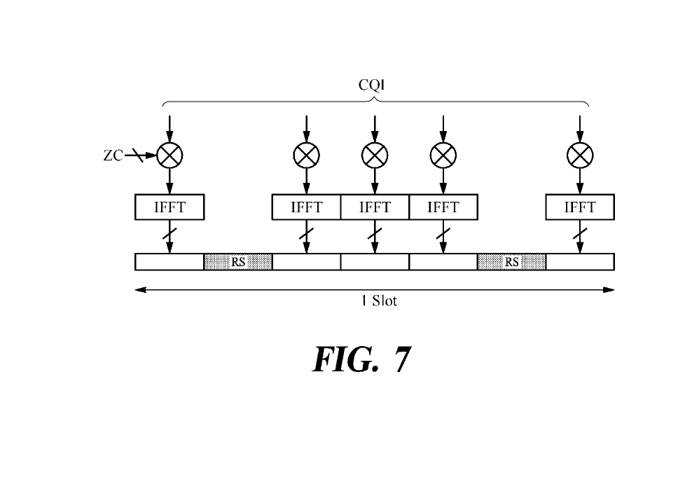

FIG. 7 is a diagram of a control channel structure in one slot for the transmission of channel quality information (hereinafter, C01) as PUCCH format 2.

Referring to FIG. 7, the same signal is repeatedly transmitted through slot-based frequency hopping in one subframe as in the example of FIG. 4 to obtain a frequency diversity gain in the order of 3 dB. According to the aforementioned control signal transmission method in consideration of multiple UEs in the resource structure for control signals, the UEs may be distinguished from each other through a spread code in time and frequency domains, or a method is applicable to distribute the effect of interference between neighboring cells by assigning different spread codes (in consideration of a correlation property) to the neighboring cells. For example, two OFDM symbols are used for an RS on one or more RSs (1 RB=12 subcarriers) as shown in FIG. 6, and therefore six UEs are distinguished from each other by using the cyclic shift of the ZC sequence in frequency domain, and different QPSK-modulated CQI information is mapped to each OFDM symbol. Thereby, 10 bits are transmitted per slot. In other words, a channel code having 1/2 code rate is applied in one subframe (1 TTI=1 msec), and up to 10 bits of information are transmitted by applying the QPSK modulation scheme.

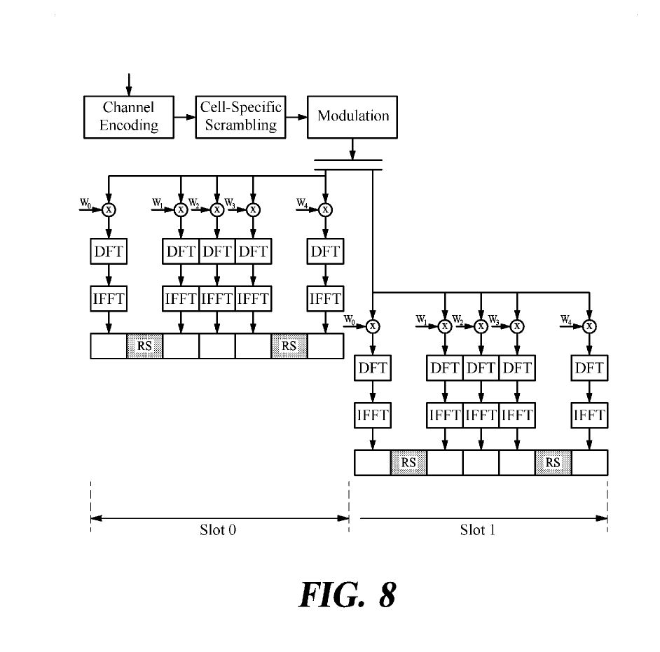

FIG. 8 is a diagram of a control channel structure for the transmission of ACK/NACK information about aggregation of a plurality of carries for PUCCH format 3.

Referring to FIG. 8, if the transmission is performed simultaneously on a plurality of component carriers in the downlink carrier aggregation, a plurality of HARQ acknowledgements need to be fed back. A UE capable of supporting more than two downlink component carriers, i.e., a UE capable of transmitting more than 4 bits for a HARQ acknowledgement should support PUCCH format 3. The basis of PUCCH format 3 is OFDM precoded with the same DFT as in the transmission method used for PUSCH. At the presence of an SR bit, the acknowledgement, that is 1 or 2 bits per downlink component carrier depending on a transmission mode set for the corresponding component carrier, is concatenated with the SR bit to form a bit train. In this case, bits corresponding to unscheduled transmission blocks are set to 0. Herein, in order to randomize the inter-cell interference after a block coding applied, scrambling is performed by using a cell-specific scrambling sequence. 48 bits made in this way are divided into two groups after being QPSK-modulated so that twelve QPSK symbols are transmitted per slot. When a normal CP is assumed, each slot has seven OFDM symbols. Similar to the case of PUCCH format 2, two OFDM symbols (one in the case of the extended CP) per slot are used for RS transmission, and five symbols are used for data transmission. In each slot, twelve QPSK symbols pre-coded with DFT are transmitted on five available DFTS-OFDM symbols. To further randomize the inter-cell interference, a cyclic shift varying among respective OFDM symbols in different patterns for respective cells is applied to a block of the twelve QPSK symbols prior to DFT precoding.

In the various cell topologies such as a femtocell and a picocell with cell coverage whose range is less than 100 m like the small cell, the wireless channel delay characteristics experienced by each cell are different from those of cells with larger coverages, which makes it desirable to design the control channel structure taking into account two channel characteristics.

1) Frequency selectivity of the wireless channel: On the wireless channel defined by delay spread, signals are received through multiple paths with various delay times. Thereby, the wireless channel has a delay profile defined by a plurality of delays not as an impulse function. This fails to provide a constant channel gain but causes a channel to be changed in frequency domain, which is said to have a frequency selectivity. For small cells, the small coverage and the mostly indoor environment that is different in channel characteristics from a relatively poor environment of the mobile communications may reduce the delay spread time to a few nanoseconds. This means an insignificant frequency selectivity to cause a large coherent bandwidth, resulting in similar channel characteristics between neighboring subcarriers.

2) Time selectivity of the wireless channel: In order to reduce the occurrence of frequent handover resulting from configuration of small cells, small cells are better used by pedestrians or stationary users, and accordingly mobility of the terminal may be restricted to a slow-moving/stationary state. This mitigates the Doppler effect affecting the change of the wireless channel to have the time selectivity of the radio channel different from fast-moving objects and then lead to a reduced channel variation between neighboring symbols. This prolongs the coherent time, resulting in a reduced channel variation between temporally neighboring subcarriers.

In addition to the advantage of time-frequency channel change that the small cell has, the small cell having less terminals than those of a macrocell necessitates a reconsideration of the multiplexing feature of control channels also. In other words, there is a need for reducing the overhead of control channel resources to efficiently utilize resources in the current legacy control channel structure and to support a smaller number of terminals than in a macrocell by using minimum resources in a control channel structure that is supportable in the small cell coverage. In addition, it may also be necessary to secure new resources for transmission of new control channel information of a terminal for supporting only the small cell.

The current PUCCH structure will be discussed as well as the channel characteristics of the small cell. With a maximum cyclic shift of the ZC sequence, thirty six UEs can be multiplexed for format 1, and twelve UEs can be multiplexed for format 2. In the small cell scenario, the number of UEs is not greater than that of UEs for the macrocell, a large portion of PUCCH resources may go to waste. Accordingly, it is necessary to maximize the resource efficiency for the small cell and to optimize PUCCH design in consideration of channel characteristics. More specifically, it is necessary to consider further segmenting the basic unit of resource allocation to enhance the usability of resources and to define PUCCH and PUSCH on the same PRB at the same time. It is necessary to lessen the load to the RF amplifier by maintaining the single carrier property and to propose a new structure suitable for small cells.

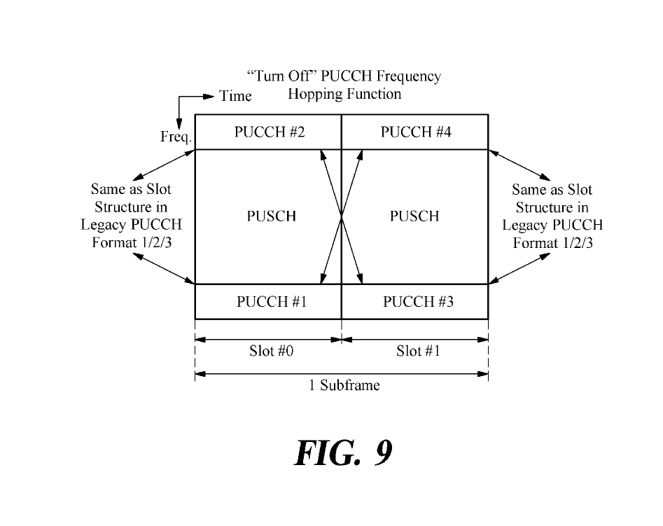

FIG. 9 is a diagram of a method for eliminating a frequency hopping with a new PUCCH structure suitable for a small cell.

The legacy PUCCH acquires a frequency diversity gain of about 3 dB through frequency hopping as in the example of FIG. 4. However, as mentioned above, the small cell may have excellent time-frequency channel characteristics compared to the macrocell, and PUCCH resources are better minimized to enhance the resource efficiency for the small cell. Accordingly, disusing the frequency hopping function may be considered in the small cell in order to allocate twice the normal amount of PUCCH resources in the same PRB as shown in FIG. 9. In this case, the legacy structure per slot of legacy PUCCH format 1/2/3 may be reused.

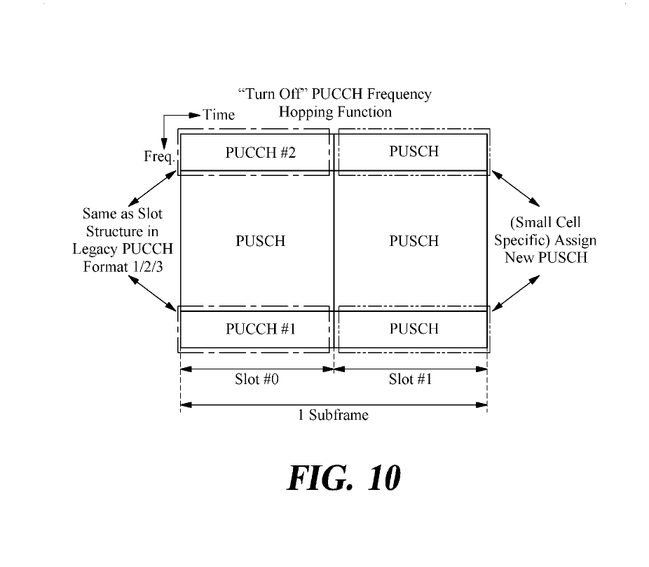

FIG. 10 is a diagram of a method for additionally allocating PUSCH after eliminating the frequency hopping with a new PUCCH structure suitable for the small cell.

The legacy PUCCH acquires a frequency diversity gain of about 3 dB through frequency hopping as in the example of FIG. 4. However, as mentioned above, the small cell may have excellent time-frequency channel characteristics compared to the macrocell, and it is better to minimize the PUCCH resources to enhance the resource efficiency for the small cell. Accordingly, disusing the frequency hopping function may be considered in the small cell in order to allocate the same PUCCH resources in the same PRB as in the case of FIG. 10 and to secure additional PUSCH resources. In this case, the legacy structure per slot of legacy PUCCH format 1/2/3 may be reused. As no frequency hopping is used, the PUSCH resources corresponding to about one slot may be additionally generated.

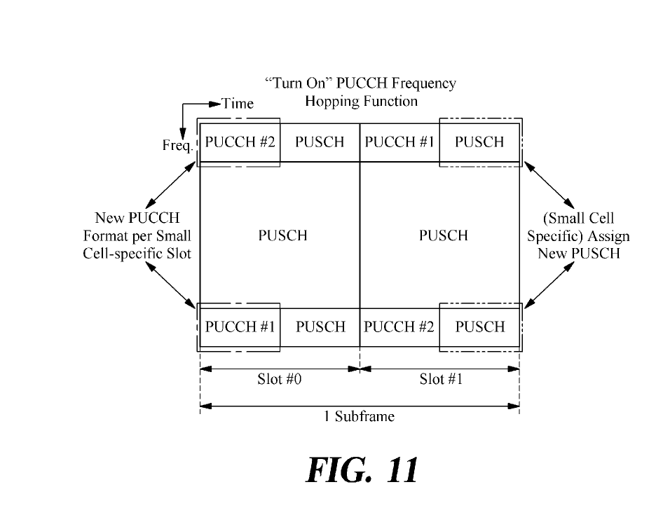

FIG. 11 is a diagram of a method for additionally allocating PUSCH taking into account the frequency hopping with a new PUCCH structure suitable for the small cell.

As described above, the small cell may have excellent time-frequency channel characteristics compared to the macrocell, and PUCCH resources are better minimized to enhance the resource efficiency for the small cell. Accordingly, a new PUCCH format per slot suitable for the small cell may be redesigned in order to secure additional PUSCH resources while allocating the same PUCCH resources in the same PRB as in the case of FIG. 11 and maintaining the frequency hopping. In this case, half of the legacy PUCCH resources are utilized as new PUCCH resources, and the other resources are additionally allocated to PUSCH. In addition, while new PUCCH per slot is illustrated in FIG. 11 as being capable of maintaining frequency diversity through frequency hopping, a further elimination of the frequency hopping is applicable to double the PUCCH resource efficiency as compared to the conventional efficiency.

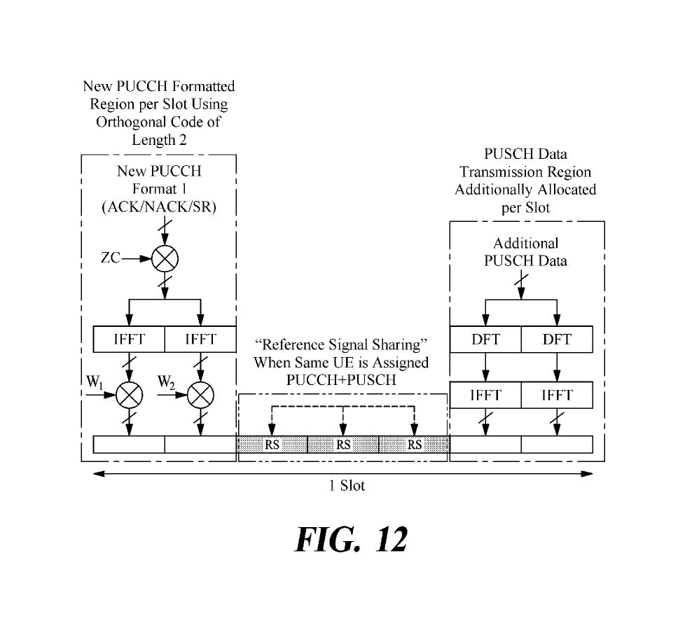

FIG. 12 is a diagram of the structure of a new PUCCH format 1 per slot suitable for a small cell to which a reference signal sharing is applied.

In the case of legacy PUCCH format 1, 1-bit or 2-bit information is transmitted by applying orthogonal codes of length 4 in consideration of the four OFDM symbols in time domain. The PUCCH format for the RS is configured by securing three orthogonal resources in time domain in consideration of three OFDM symbols. Referring to FIG. 12, it is proposed that four symbols for time-domain spread for legacy PUCCH information transmission be reduced to two symbols through PUCCH format 1 suitable for the small cell, and an interval of about two symbols which are additionally produced in a slot be allocated to PUSCH data. In this case, the technique of reference signal sharing may be applied. In the case of simultaneous transmission of new PUCCH and PUSCH, if PUCCH and PUSCH are allocated to the same user (UE) at the same time, the corresponding RS may be utilized in demodulating both the PUCCH and PUSCH. Accordingly, the legacy PUCCH RS may be used without being additionally distinguished. In this case, a larger number of RS OFDM symbols is assigned to time domain, and thus resources of the RS may be reallocated to PUSCH. As the length of orthogonal spread is changed from 3 to 2 for new PUCCH format 1 as above, the range in which UE multiplexing is allowed is reduced from thirty six supportable UEs of the conventional case to twenty four supportable UEs in consideration of the maximum cyclic shift 12. If frequency hopping is additionally eliminated as in the case of FIG. 11, forty eight UEs can be supported. The DFT-S-OFDM technique applied to legacy uplink may be employed to transmit the added PUSCH channel.

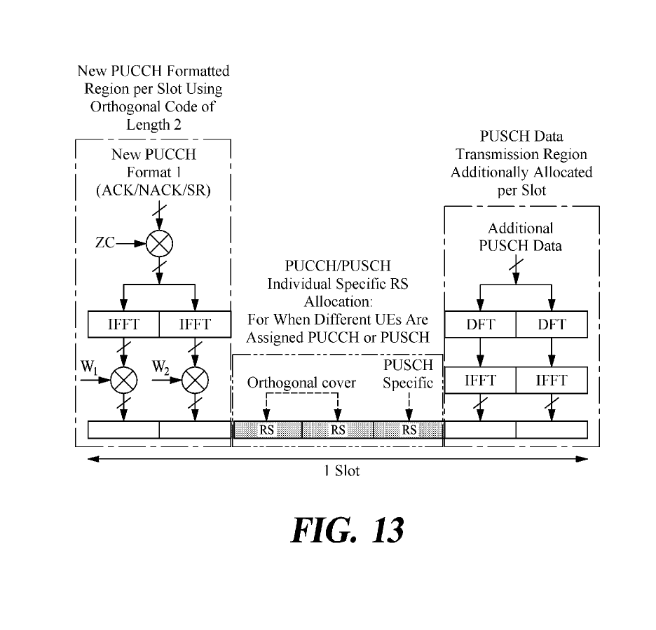

FIG. 13 is a diagram of the structure of a new PUCCH format 1 per slot which is suitable for a small cell and assigned a PUSCH-specific reference signal.

In the case of legacy PUCCH format 1, 1-bit or 2-bit information is transmitted by applying four orthogonal codes in consideration of 4 OFDM symbols in time domain. The PUCCH format for the RS is configured by securing three orthogonal resources in time domain in consideration of three OFDM symbols. Referring to FIG. 12, it is proposed that four symbols for the time-domain spread for the legacy PUCCH information transmission be reduced to two symbols through PUCCH format 1 suitable for the small cell, and an interval of about two symbols which are additionally generated in a slot be allocated to PUSCH data. In this case, a PUSCH-specific reference signal may be allocated. In case of simultaneous transmission of new PUCCH and PUSCH, if the PUCCH and PUSCH are not simultaneously allocated to the same user (UE), but different users use the PUCCH and the PUSCH, then the corresponding RS cannot be utilized in demodulating both the PUCCH and PUSCH. Accordingly, a dedicated RS may be allocated to new PUCCH format 1 and the added PUSCH-specific RS may be distinctively allocated. In this case, assuming that new PUCCH format 1 uses a length-2 spread code, time spread of the same length may be also applied to the PUCCH-specific RS to maintain one-to-one mapping for user multiplexing. In addition, an RS of at least one symbol may be allocated as a PUSCH-specific signal for use in demodulating the PUSCH. According to at least one embodiment of the present disclosure, the PUSCH involves not only the transmission of new control information which has not been conventionally defined, but also the transmission of data other than the information defined in legacy PUCCH format 1/2/3.

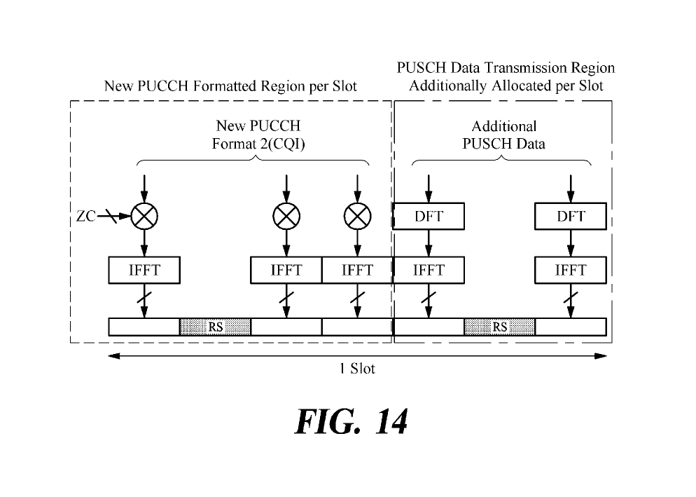

FIG. 14 is a diagram of the structure of a new PUCCH format 2 per slot suitable for a small cell.

For the legacy PUCCH format 2, five OFDM symbols per slot are used for transmission of QPSK information. For CQI, to which channel coding is applied with a block code such as an RM code, the amount of transmittable information may be increased through a channel code by increasing the coding rate. Accordingly, in the case of the small cell, the efficiency of PUCCH resources may be enhanced by increasing the coding rate and minimizing PUCCH occupied resources. The present disclosure proposes that some symbols of the legacy PUCCH format 2 be allocated as PUSCH resources such that the PUCCH and the PUSCH can be transmitted simultaneously within the same PRB. In the example of FIG. 14, three OFDM symbols and one RS are defined as the new PUCCH format 2, and two OFDM symbols and one RS are allocated to the PUSCH. The number of the symbols for the PUCCH and the PUSCH may be set arbitrarily. The RS may be used by the user to demodulate both the PUCCH and the PUSCH.

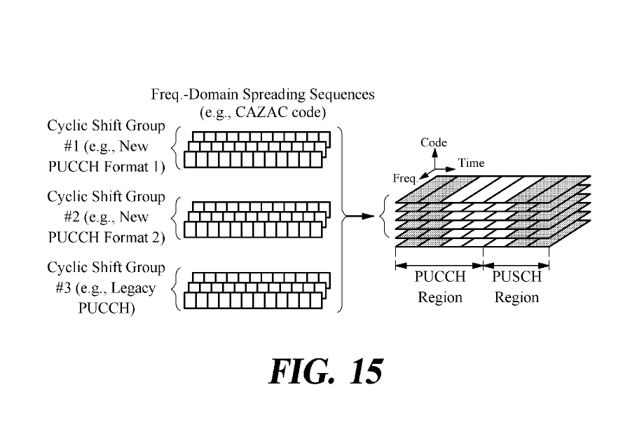

FIG. 15 is an examplary diagram of the coexistence of different PUCCH formats and PUSCHs in the same PRB by using the cyclic shift of a ZC sequence.

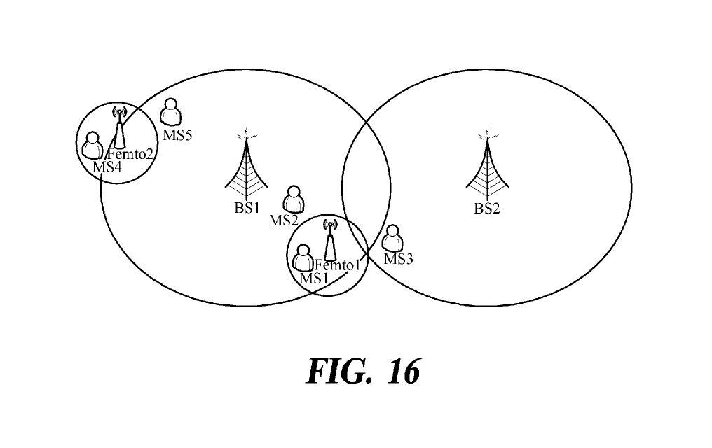

FIGS. 12 to 14 propose new structures for PUCCH formats 1 and 2. To enhance the efficiency of resources, coexistence of new PUCCH formats 1 and 2 in the same PRB also needs to be taken into account. The PUCCH formats may be distinguished from each other by differently applying cyclic shifts of ZC sequences. Accordingly, it is appropriate to maintain the same PUCCH region to which the ZC sequence is applied between formats 1 and 2. For example, the formats as in FIGS. 13 and 14 may coexist within the same PRB, if the preceding 4-symbol interval is set as the PUCCH region, and by using cyclic shifts of different ZC sequences. The PUSCH is allocated to a specific UE, which makes the PUSCH distinguishable from the PUCCH formats. Herein, RSs can be distinguished from each other by the same ZC sequence cyclic shift, but it is better to align the positions and number of RSs between the PUCCH formats in consideration of the importance of the RSs. Further, the PUCCH formats and legacy PUCCH may also coexist by differently applying cyclic shifts of ZC sequences. In this case, the same ZC sequence spreading method may be considered for the structure of the PUSCH in order to minimize interference with the legacy PUCCH. FIG. 16 is a diagram of an interference scenario taking into account a neighboring macrocell in a small cell environment.

Referring to FIG. 16, BS1 and BS2 are base stations of a macrocell, MS2 and MS5 are macro MSs connected to BS1, MS3 is a macro MS connected to BS2, MS1 is a femto MS connected to Femtol, and MS4 is an MS connected to Femto2. The large circle and the small circle represent coverages of the Macro BS and the Femto BS, respectively. In other words, the coverage of the Macro BS is different from that of the Femto BS since the Macro BS performs a transmission with a high power, while the Femto BS performs the transmission with a low power. The network layout as above may experience the following problems.
Case1. Both Macro and Femto on Downlink: When the Macro BS performs a downlink transmission to MS2, the downlink performance of MS2 is degraded by the downlink signal of the BS of Femtol (Femto close to MS2).
Case2. Macro on Downlink and Femto on Uplink: When the Macro BS performs a downlink transmission to MS2, the downlink performance of MS2 is degraded by the signal of MS1 of Femtol (Femto MS close to MS2).
Case3. Macro on Uplink and Femto on Downlink, with Femtol positioned close to BS1: When macro MS2 performs an uplink transmission to BS1, the uplink performance of MS2 is degraded by the downlink signal of Femtol (Femto close to BS1).
Case4. Both Macro and Femto on Uplink, with Femtol positioned close to BS1: When macro MS2 performs an uplink transmission to BS1, the uplink performance of MS2 is degraded by the uplink signal of MS1 of Femtol (a Femto MS positioned close to BS1).

In order to effectively attenuate an interference between various macro-small cells (which are assumed to be femtocells in this example), a terminal is required to deliver information about nearby interference to the base station (the macro or femtocell base station). For example, when a terminal served by a femtocell has a difficulty in receiving the uplink signal due to the uplink signal of another terminal attempting to access or being served by a nearby macrocell (Case 4 of FIG. 16), the femtocell needs a user signal detection & indicator for identifying whether the difficulty in receiving the uplink signal results from the weak signal, a temporary problem or strong nearby interference. The terminal may transmit such signal periodically or aperiodically (according to request from a terminal/base station) through resources pre-allocated by a small cell base station such that the small cell base station in receipt of the signal can determine whether a signal detection error has occurred due to a nearby interference or is simply temporary, based on the strength of the signal of the terminal.

In addition, in order to more effectively manage interference between small cells and macrocells, an effective mechanism is needed for a base station to obtain the effective degree of interference to the terminal served by a small cell. For example, if a terminal served by a macrocell has difficulty in receiving a signal from the macrocell due to a strong signal from a nearby small cell base station (Case 1 of FIG. 16), the terminal may inform the macro base station of the degree of the nearby interference such that the transmit power or resources of the small cell can be readjusted, or the interference can be attenuated or cancelled. This needs a new uplink information transmission channel through which the terminal can quickly indicate the degree of interference. Even if various terminals perform transmissions at the same time, such channel may allow the base station to measure the degree of interference of all of the terminals based on strengths of received signals, or allow the base station to measure the degree of interference for each of grouped terminals by causing the grouped terminals to transmit the relevant information through different, new transmission channels.

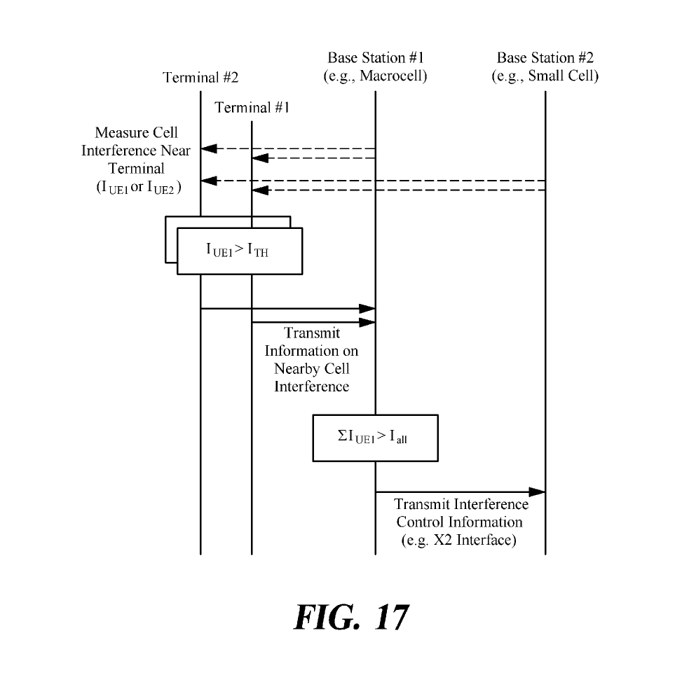

FIG. 17 is an examplary of a cooperation between base stations based on feedback from a terminal with a macro/small cell interference coordination.

Referring to FIG. 17, a plurality of terminals receives signals from a plurality of nearby base stations and measures the degrees of interference (e.g., I_{UE1} or I_{UE2}) of the base stations. Based on the degree of interference to each terminal, a terminal suffering from an interference higher than or equal to a specific level transmits the interference information to a base station (serving base station) which serves the terminal through a newly defined interference information transmission channel. Upon receiving the information, the base station determines whether or not the interference of a neighboring cell needs to be controlled based on the interference information received from one or more terminals, and transmits, if necessary, corresponding control information or interference information to neighboring base stations through an inter-base station interface such as the x2 interface.

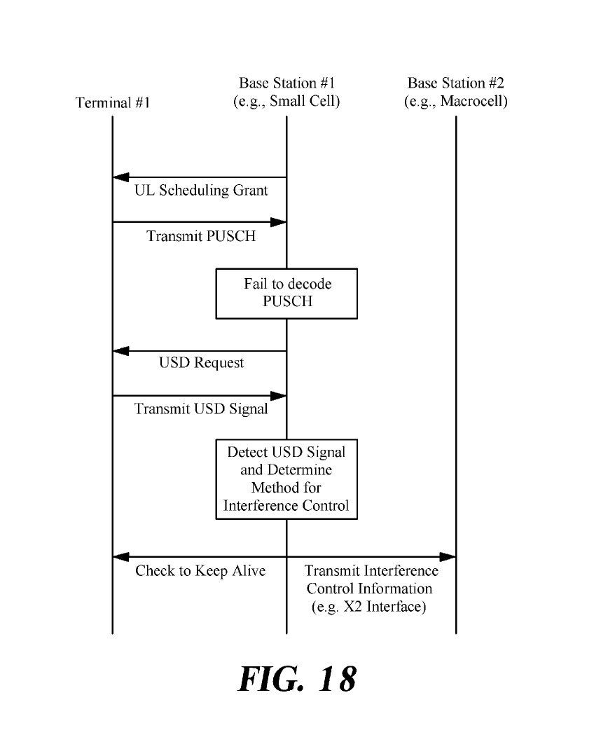

FIG. 18 is a diagram of a process, performed by a base station, for recognizing the state of interference of a terminal and controlling the interference with a macro/small cell interference coordination.

Referring to FIG. 18, it is assumed that a terminal which was granted an uplink resource allocation and scheduling by the base station has transmitted uplink data through PUSCH, and that the base station has failed in demodulating the same. Against the assumption of the base station that the terminal has transmitted the uplink data through the PUSCH, it may have not been transmitted by the terminal that missed the uplink (UL) grant. Otherwise, the terminal may have transmitted the PUSCH, but the base station may have failed to demodulate the PUSCH because of an excessive interference from a neighboring base station. Accordingly, in order for the base station to receive the uplink data of the terminal, it is important for the base station to determine whether or not the terminal is suffering from an interference. To this end, the base station requests that the terminal transmit a preset user-signal-detection signal, and the terminal in receipt of the request transmits the signal through a newly designed USD channel. Once the base station detects the signal, the base station may determine whether the terminal suffers from an interference or a simple link failure has occurred, and then perform a re-access or checking of access state such as checking whether the terminal is kept alive, and make an interference control request to a nearby base station.

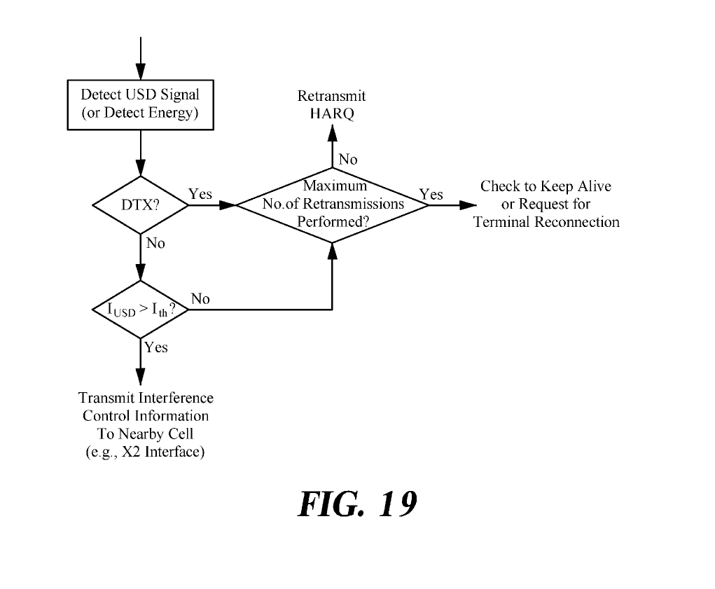

FIG. 19 is a diagram of a specific operational process of a base station for detecting a user signal.

Referring to FIG. 19, the USD signal may be provided by a specific modulated information, or it may be in the form of power/energy detected indicating the strength of a detected signal. Upon detecting the USD signal, the base station determines whether a USD signal exists (DTX detection). If this detects a DTX and the base station has performed the maximum number of retransmissions, the base station rechecks the service or access state of the terminal. In detecting the USD signal, the USD signal is used rather than the DTX to obtain an interference information (or link level information between the terminal and the base station), based on which it is determined whether to control the interference by a nearby cell. When the interference control is needed, a request for interference control is made to a nearby base station through, for example, the x2 interface, or a HARQ retransmission is performed or the access state of the terminal is rechecked based on whether the maximum number of retransmissions has been reached.

To implement the small cell interference control as above, an information transmission channel is needed for directly or indirectly measuring an interference information. To obtain functions capable of coexisting with terminals for 3GPP LTE Release 8 and a later version and transmitting a differentiated additional information, it is appropriate to find resources for making the best reuse of the conventional legacy system while allowing an additional channel allocation. According to 3GPP TS 36.211 V11.1.0 (2012-12) “Evolved Universal Terrestrial Radio Access (E-UTRA); Physical Channels and Modulation (Release 11)”, the legacy PUCCH format 1 uses a length-4 orthogonal code to apply time-domain spread to a 4-OFDM symbol interval for ACK/NACK or SR transmission, and uses a length-3 orthogonal code for time-domain spread of the RS region. The orthogonal codes used in this case are shown in Tables 1 and 2. As can be seen from the tables, for PUCCH format 1, the number of symbols in the RS transmission interval differs from that in the information transmission interval, and one of length-4 orthogonal codes is not used in order to maintain one-to-one mapping between time-domain spread codes. In other words, a selective one-to-one mapping of three sequences of sequence indexes 0, 1 and 2 is maintained between length-4 and length-3 orthogonal codes, as shown in Tables 1 and 2. Accordingly, the length-4 orthogonal code [+1 +1 −1 −1] can be used for an extra purpose.

TABLE 1

| Sequence index | |
|---|---|
| | Orthogonal sequences (length 4) |
| 0 | [+1 +1 +1 +1] |
| 1 | [+1 −1 +1 −1] |
| 2 | [+1 −1 −1 +1] |
| | Orthogonal sequences (length 2) |
| 0 | [+1 +1 +1] |
| 1 | [1 e^{j2π/3} e^{j4π/3}] |
| 2 | [1 e^{j4π/3} e^{j2π/3}] |

The additional length-4 time-domain spread code is difficultly mapped by the length-3 spread code for the RS as above, and therefore the transmission of the interference information can be achieved by transmitting the aforementioned interference level information as the energy/power level through a modulation technique in consideration of a non-coherent or other demodulation schemes, or transmitting an interference information on a limited level (e.g., 1 to 2-bit information) after a demodulation.

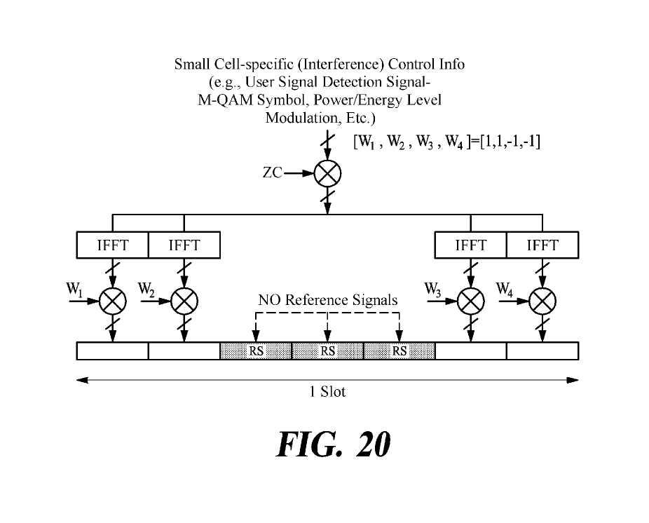

FIG. 20 is a diagram of a proposed transmission channel structure of small cell-specific control information in association with the detection of the user signal.

Referring to FIG. 20, legacy PUCCH Format 1 may be reused, and [+1 +1 −1 −1], which is currently not in use, may be used as a time-domain spread code to transmit an interference, a control information and the like which are suitable for the small cell. As can be seen in FIG. 20, the RS uses all three DFT codes in PUCCH Format 1, and thus a corresponding new length-4 channel may be transmitted without the RS. In addition, the transmission of small cell-specific control information may be achieved by transmitting the aforementioned user signal detection signal, or transmitting an interference information on the power/energy level wherein the degree of interference is a measure of the sum of power/energy levels transmitted by a plurality of terminals. Further, any control information of a few bits or less may be transmitted through a demodulation technique such as M-QAM.

### CROSS-REFERENCE TO RELATED APPLICATION

If applicable, this application claims priority under 35 U.S.C §119(a) of Patent Application No. 10-2013-0048982, Patent Application No. 10-2013-0048984, and Patent Application No. 10-2013-0048986, commonly filed on Apr. 30, 2013 in Korea, the entire contents of which are incorporated herein by reference. In addition, this non-provisional application claims priorities in countries, other than the U.S., with the same reason based on the Korean Patent Applications, the entire contents of which are hereby incorporated by reference.

1. A cellular communication method involving a plurality of base stations including a macrocell, the cellular communication method comprising:
acquiring, by a terminal, an interference information of a neighbor cell from signals received from the plurality of base stations;
transmitting, by the terminal, the interference information of the neighbor cell to a serving base station;
determining a neighbor cell interference control request based on one or more interference informations received from one or more terminals; and
transmitting an interference control information to a nearby base station.

2. The cellular communication method of claim 1, wherein the interference information of the neighbor cell comprises at least one of a picocell, a microcell and a femtocell as a small cell.

3. The cellular communication method of claim 1, wherein the terminal transmits the interference information of the neighbor cell to the base station by using a time-frequency resource which is a common resource for use by the terminals.

4. The cellular communication method of claim 3, wherein the interference informations of a plurality of the terminals received through the common resource is acquired through a detection of a power or energy level.

5. A method for transmitting a control signal in a wireless communication system, the method comprising:
allocating four OFDM symbols in a slot for a transmission of the control signal; and
spreading the control signal in time domain by using a length-4 sequence [+1, +1, −1, −1] to transmit the control signal.

6. The method of claim 5, wherein the control signal comprises a cell specific control information, the cell having a small coverage.

7. The method of claim 6, wherein the control signal includes a signal for detecting a user signal strength and an information indicating interference of a neighbor cell.

8. The method of claim 5, wherein the control signal is transmitted through an M-QAM modulation.
